(19) United States
(12) Patent Application Publication
(10) Pub. No.: US 2018/0223392 A1
(43) Pub. Date: Aug. 9, 2018

(54) COMPOSITIONS AND METHODS FOR RECOVERY OF ALKALINE METALS

(71) Applicant: Lixivia, Inc., Santa Barbara, CA (US)

(72) Inventor: Michael D. Wyrsta, Santa Barbara, CA (US)

(21) Appl. No.: 15/892,978

(22) Filed: Feb. 9, 2018

Related U.S. Application Data
(60) Provisional application No. 62/457,091, filed on Feb. 9, 2017.

(51) Int. Cl. C22B 26/12; H01M 10/54

(52) U.S. Cl. CPC C22B 26/12; H01M 10/54

(57) ABSTRACT

A method for extracting an alkali metal element comprises contacting a sample comprising a first alkali metal salt with a first lixiviant, the first lixiviant comprising a first amine cation and a first counterion, wherein the first alkali metal salt comprises a first alkali metal element, and wherein the first lixiviant is selected to react selectively with the first alkali metal salt. The method forms a depleted sample and a first supernatant comprising a first uncharged or charged amine, and a first soluble complex comprising a cation of the first alkali metal element and the first counterion. The method further transfers the first alkali metal element cation from the first supernatant, and regenerates the first amine cation by the addition of a first precipitant or salt forming agent.

### FIELD OF THE INVENTION

The field of the invention is hydrometallurgy, particularly as it is related to the extraction or recovery of alkaline metals.

### BACKGROUND

The following description includes information that may be useful in understanding the present invention. It is not an admission that any of the information provided herein is prior art or relevant to the presently claimed invention, or that any publication specifically or implicitly referenced is prior art.

Lithium is a low atomic weight, alkali metal group element that is present in a variety of natural sources (for example, ores and brines) in the form of various salts. Due in part to production of lightweight, high energy density batteries (such as those used in portable electronic devices) the demand for lithium is steadily increasing. Such uses, however, require lithium of very high purity in order to provide optimal results. Unfortunately, both natural and man-made sources of lithium (such as scrap and industrial waste) include a wide variety of contaminating metals and other elements. For example, spent lithium-based batteries, lithium containing lubricating greases, continuous casting mold flux slags, lithium-based dessicants for gas streams, and lithium containing foundry sand can be sources of lithium. Consequently, there is a substantial need for methods that can provide high grade lithium (generally in the form of a salt) from a variety of sources.

For example, International patent application Ser. No. WO 2011/082444, to Tan, discusses a method for extracting high-grade lithium from spodumene ores. All publications identified herein are incorporated by reference to the same extent as if each individual publication or patent/application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The described process relies on nonselective leaching of lithium from the ore as a sulfate salt, along with numerous undesirable metals. Removal of these undesired metals requires significant additional processing steps (including treatment with ion exchange resin) and repeated crystallization of the extracted lithium as a carbonate salt in order to provide high purity.

International Patent Application Publication No. 2012/050317, to Sonu et al, describes a method for extracting lithium from battery-related wastes by extraction with a combination of an inorganic acid and hydrogen peroxide. Unfortunately the process is nonselective and also extracts several other metals that have to be removed sequentially in order to provide a solution that primarily contains lithium, and which requires repeated crystallization in order to provide lithium of high purity.

International Patent Application Publication No. WO 2013/140039, to Tiihonen and Haavanlammi, describe a method for extracting lithium from a variety of natural sources by nonselective leaching at high temperatures using a sodium carbonate solution. This process produces a crude lithium carbonate that is solubilized by reacting it with carbon dioxide to form a soluble lithium bicarbonate. The described process, however, requires substantial further processing of the resulting lithium bicarbonate solution in order to remove contaminating metals (typically treatment with a cation exchange resin) in order to provide high purity lithium.

Thus, there is still a need for a method that provides simple and economical isolation of lithium and/or other alkali metal family elements at high purity.

### SUMMARY OF THE INVENTION

The inventive subject matter provides hydrometallurgical systems, methods, and compositions in which amine-based lixiviants are utilized in substoichiometric amounts to recover alkaline earths from raw or waste materials. The lixiviant can be regenerated and recycled for use in subsequent iterations of the process or returned to a reactor in a continuous process. Extraction of the alkaline earth from the raw material and precipitation of the extracted alkaline earth is performed in the same reactor and essentially simultaneously.

One embodiment of the inventive concept is a method for extracting an alkaline metal element (e.g., lithium) from an alkaline earth-bearing raw material or waste product. In such a method, the raw material (for example, a steel slag), an amine cation and counterion containing lixiviant, and a precipitant (i.e. a compound that reacts with an alkaline earth released from the raw material to form a precipitate, for example, a gas that contains CO₂) are brought into contact in reactor. In some embodiments, the precipitant is preferably calcium carbonate (or other carbonate salt) because it is chemically stable and remains in discrete solid portions. However, precipitants can comprise any compound that reacts with alkaline earth. The lixiviant is provided in substoichiometric amounts relative to the amount of alkaline metal element available in the raw material. The subsequent series of reactions produces an alkaline earth precipitate and an extracted raw material, and in the process regenerates the lixiviant species. The alkaline earth precipitate and the extracted raw material are separated, and some or all of the regenerated lixiviant is returned to the reactor.

The alkaline earth precipitant and the extracted raw material can be separated on the basis of particle size/diameter, particle density, and/or differential magnetic properties. Suitable separators include settling tanks filters, centrifugal separators, and magnetic separators. For example the reactor, or a portion thereof, can be configured as a settling tank. In some embodiments the separation is performed on a batch basis. In other embodiments the separation is performed on a continuous basis.

In some embodiments of the inventive concept, the raw material, the lixiviant, and/or the precipitant are added to the reactor in an essentially continuous manner. Similarly, in other embodiments of the inventive concept the separation process is performed in an essentially continuous manner.

In still other embodiments of the inventive concept the extracted raw material, which is relatively enriched in non-extracted elements following extraction of the alkaline earth component, is not discarded, but rather is retained and subjected to further processing.

### BRIEF DESCRIPTION OF THE DRAWINGS

FIG. 1 schematically depicts steps A through F of an example of a method of the inventive concept in which lithium is removed from slag to generate a processed slag, using an organic amine chloride lixiviant that is regenerated.

FIG. 2 schematically depicts a method of the inventive concept, in which an alkaline earth element is removed from slag using a lixiviant to produce a processed slag. The lixiviant is subsequently regenerated.

FIG. 3 schematically depicts another method of the inventive concept, in which different alkaline earth elements are removed from slag in a stepwise fashion to produce a processed slag.

FIG. 4 schematically depicts an alternative embodiment of the inventive concept, in which different alkaline earth elements are removed from slag to produce a processed slag.

### DETAILED DESCRIPTION

Throughout the following discussion, numerous references will be made regarding lixiviants. A lixiviant should be understood to be a chemical entity that has the ability to selectively extract metals or metal ions from inorganic or organic solids in an aqueous or other solvent mixture.

The inventors have discovered a hydrometallurgical method for the selective recovery of lithium and/or other alkali metal (IUPAC Group I) elements (i.e., alkali metals) through the use of lixiviants that include organic amines and inorganic amines. In addition, the inventors have determined that such inorganic or organic amine-based lixiviants can be regenerated using carbon dioxide, or other chemicals such as acids, ion exchange resins and salts.

Organic amines can be organic derivatives of ammonia in which one or more hydrogens of ammonia are replaced by organic groups. Inorganic amines are inorganic nitrogen compounds with the general formula NR₃ not found in living organisms. For example, inorganic amines can include, but are not limited to, chloramines, ammonia borane, dichloramine, hydroxylamine, nitrogen tribromide, nitrogen trichloride, nitrogen trifluoride, and nitrogen triiodide.

The following discussion provides many exemplary embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used in the description herein and throughout the claims that follow, the term “about” means within 10% of the indicated value, unless the context clearly dictates otherwise. For example, about one centimeter includes a range from 0.9 cm to 1.1 cm.

It is contemplated that any intermediate product produced by the inventive process can be considered an end product to be used in any viable application based on its physical and/or chemical properties. For example, an intermediate with sufficient compressive strength and chemical stability to be included in building materials can be taken a repurposed for that application.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Embodiments of the inventive process can include at least one compound of the general composition depicted in Compound 1 for use with any source of material that contains one or more a form(s) of an alkali metal hydroxide forming species, that can be hydrated to form AM(OH) or other hydrated species that would react selectively with lixiviants of the form found in Equation 1. Suitable materials include natural sources, such as ores and brines, as well as man-made sources such as battery wastes and industrial wastes. Such hydrated forms may be present in the material as it is obtained from nature or can be introduced by processing (for example through treatment with a base, hydration, or by oxidation), and can be stable or transient. Selective extraction of the desired alkali metal can, for example, be based on the presence of a metal hydroxide that has a stronger basicity than the organic amine-based lixiviants used in the extraction process.

Organic amines suitable for use as a lixiviant can have the general formula shown in Compound 1, where N is nitrogen, H is hydrogen, and X is a counterion (i.e., a counter anion).

Compound 1

Ny,R₁,R₂,R₃,H—Xz

Suitable counterions can be any form or combination of atoms or molecules that produce the effect of a negative charge. Counterions can be halides (for example fluoride, chloride, bromide, and iodide), anions derived from mineral acids (for example nitrate, phosphate, bisulfate, sulfate, silicates), anions derived from organic acids (for example carboxylate, citrate, malate, acetate, thioacetate, propionate and, lactate), organic molecules or biomolecules (for example acidic proteins or peptides, amino acids, nucleic acids, and fatty acids), and others (for example zwitterions and basic synthetic polymers).

A wide variety of ionic compounds are suitable for use as lixiviant species. For example, ammonium chloride, ammonium bromide, ammonium acetate, ammonium fluoride, ammonium proprionate, ammonium lactate, ammonium nitrate, any combination of a strong acid and a weak base, any combination of any weak base and a weak acid, any combination of a strong base and weak acid, any combination of a strong base and a strong acid, naturally occurring or non-naturally occurring amino acids, and monoethanolamine hydrochloride are contemplated as suitable lixiviant species.

In particular regard to organic amines, monoethanolamine hydrochloride (MEA-HCl, HOC₂H₄NH₃Cl) conforms to Compound 1 as follows: one nitrogen atom (N₁) is bound to one carbon atom (R₁=C₂H₅O) and 3 hydrogen atoms (R₂, R₃ and H), and there is one chloride counterion (X₁=Cl—). Compounds having the general formula shown in Compound 1 can have a wide range of acidities, and an organic amine of the inventive concept can be selected on the basis of its acidity so that it can selectively react with one or more alkali metal salts or oxides from a sample containing a mixture of alkali metal salts or oxides. Such a compound, when dissolved in water or another suitable solvent, can (for example) selectively extract the alkali metal element lithium presented in the form lithium hydroxide in a suitable sample (for example, following treatment of an obtained sample with a base such as NaOH and/or lime). Alternatively, such a lixiviant can be used to selectively generate a specific lithium salt (for example, a salt that is soluble in an organic solvent) in a lithium-containing brine. Equation 1 depicts a primary chemical reaction in extracting an insoluble alkali metal (AM) salt (in this instance a hydroxide salt) from a suitable source using an organic amine cation (OA—H+)/counterion (Cl—) complex (OA—H+/Cl—) as a lixiviant. Note that the OA—H+/Cl— complex dissociates in water into OA——H+ and Cl—.

AM(OH)(solid or soluble)+OA—H+(soluble)+Cl—(aq)→AMCl(soluble)+OA (soluble)+H₂O Equation 1

The counterion (Cl—) is transferred from the organic amine cation (OA—H+) to the alkali metal salt to form a soluble alkali metal/counterion complex (AMCl), uncharged organic amine (OA), and water. Once solubilized, the alkali metal/counterion complex can be recovered from solution by any suitable means. For example, addition of a second counterion (SC) in an acid form (for example, H₂SC), which reacts with the alkali metal cation/counterion complex to form an insoluble alkali metal salt (AMSC), can be used to precipitate the extracted alkali metal from supernatant and release the counterion to regenerate the organic amine cation/counterion pair, as shown in Equation 2.

2 AMCl(soluble)+2 OA (soluble)+H₂SC→ (AM)₂SC salt (solid)+2 OA+ (soluble)+2 2 Cl— Equation 2

Examples of suitable second counterions include polyvalent cations, for example carbonate (which can be supplied as CO₂), sulfate, sulfite, chromate, chlorite, and hydrogen phosphate.

In other embodiments, a relatively soluble alkali metal/counterion salt (for example, LiCl) generated selectively by the lixiviant can be extracted into a second, non-aqueous solvent system. Suitable non-aqueous solvent systems include straight chain and/or branched C4+ alcohols (i.e. butanol, pentanol, hexanol, etc.). Such a second, non-aqueous phase can be provided in a batch mode by mixing with the aqueous alkali metal/counterion solution, followed by separation (for example, by decanting, centrifugation, and/or decanting). Alternatively, the non-aqueous solvent and the alkali metal/counterion containing aqueous solution can be exposed to one another in a counterflow arrangement to provide continuous extraction. Once extracted into the non-aqueous solvent the alkali metal can be precipitated as described above, for example by contact with carbon dioxide to form an insoluble or relatively insoluble carbonate salt of the alkali metal. Alternatively, the non-aqueous solvent can be removed by evaporation to leave the solvated alkali metal/counterion behind as a solid. In such embodiments the non-aqueous solvent can be recovered (for example, by condensation or distillation) and re-used.

In other embodiments, selective methods such as ion exchange and/or membrane filtration (e.g. reverse osmosis) can be used to separate the alkali metal/counterion salt from the aqueous solution. For example, a selective cation exchanger can be used to extract an alkali metal ion from an aqueous solution, followed by elution of the alkali metal. Such ion exchange can be performed using a fixed bed reactor or a fluidized bed reactor with appropriate media. Similarly, membrane filtration can be used to separate an alkali metal ion from other species in the aqueous solution on the basis of size and/or charge. Alternatively, pH changes, temperature changes, or evaporation can be used to precipitate the solubilized alkali metal. In some embodiments, the alkali metal element can be recovered by electrodeposition processes, such as electrowinning or electrorefining.

In a preferred embodiment of the inventive concept, the alkali metal element can be recovered by precipitation through reaction of the mixture with carbon dioxide (for example, following extraction into a non-aqueous solvent), which advantageously regenerates the lixiviant as shown below. It should be appreciated that the process of recovering the alkali metal element can be selective, and that such selectivity can be utilized in the recovery of multiple alkali metal elements from a single source as described below. Such selectivity can, for example, be provided by selecting a series of lixiviant species having different basicities and applying such lixiviants to extracted materials in a serial manner.

The organic amine cation/counterion complex can be produced from the uncharged organic amine to regenerate the OA—H+/Cl— lixiviant, for example using an acid form of the counterion (H—Cl), as shown in Equation 3.

OA+H—Cl→OA—H+ + Cl— Equation 3

In some embodiments of the inventive concept the reaction described in Equation 3 can be performed after the introduction of an uncharged organic amine to a source of an alkali metal element, with the lixiviant being generated afterwards by the addition of an acid form of the counterion. This advantageously permits thorough mixing of the alkali metal source with a lixiviant precursor prior to initiating the reaction.

Organic amines suitable for the extraction of alkali metal elements (for example from lithium containing ores, brines, and/or battery or industrial wastes) can have a pKa of about 7 to about 14 or about 8 to about 14, and can include protonated ammonium salts (i.e., not quaternary). In preferred embodiments, the organic amines used to extract alkali metal elements are in a pKa range of about 8 to about 12. In more preferred embodiments, the organic amines used to extract alkali metal elements are in a pKa range of about 8.5 to about 11. In the even more preferred embodiments, the organic amines used to extract alkali metal elements are in a pKa range of about 9 to about 10.5. Examples of suitable organic amines for use in lixiviants include weak bases such as ammonia, nitrogen containing organic compounds (for example monoethanolamine, diethanolamine, triethanolamine, morpholine, ethylene diamine, diethylenetriamine, triethylenetetramine, methylamine, ethylamine, propylamine, dipropylamines, butylamines, diaminopropane, triethylamine, dimethylamine, and trimethylamine), low molecular weight biological molecules (for example glucosamine, amino sugars, tetraethylenepentamine, amino acids, polyethyleneimine, spermidine, spermine, putrecine, cadaverine, hexamethylenediamine, tetraethylmethylenediamine, polyethyleneamine, cathine, isopropylamine, and a cationic lipid), biomolecule polymers (for example chitosan, polylysine, polyornithine, polyarginine, a cationic protein or peptide), and others (for example a dendritic polyamine, a polycationic polymeric or oligomeric material, and a cationic lipid-like material), or combinations of these. In some embodiments of the inventive concept the organic amine can be monoethanolamine, diethanolamine, or triethanolamine, which in cationic form can be paired with nitrate, bromide, chloride or acetate anions. In other embodiments of the inventive concept the organic amine can be lysine or glycine, which in cationic form can be paired with chloride or acetate anions. In a preferred embodiment of the inventive concept the organic amine is monoethanolamine, which in cationic form can be paired with a chlorine anion.

Such organic amines can range in purity from about 50% to about 100%. For example, an organic amine of the inventive concept can have a purity of about 50%, about 55%, about 60%, about 65%, about 70%, about 75%, about 80%, about 85%, about 90%, about 95%, about 97%, about 99%, or about 100%. In a preferred embodiment of the inventive concept the organic amine is supplied at a purity of about 90% to about 100%. It should be appreciated that organic amines can differ in their ability to interact with different members of the alkali metal family and with contaminating species, and that such selectivity can be utilized to provide highly selective recovery of a desired alkali metal from a mixture present in a raw material and/or in the selective (e.g. sequential) recovery of multiple alkali metals as described below.

Inventors further contemplate that zwitterionic species can be used in suitable lixiviants, and that such zwitterionic species can form cation/counterion pairs with two members of the same or of different molecular species. Examples include amine containing acids (for example amino acids and 3-aminopropanoic acid), chelating agents (for example ethylenediamine-tetraacetic acid and salts thereof, ethylene glycol tetraacetic acid and salts thereof, diethylene triamine pentaacetic acid and salts thereof, and 1,2-bis(o-aminophenoxy)ethane-N,N,N′,N′-tetraacetic acid and salts thereof), and others (for example betaines, ylides, and polyaminocarboxylic acids).

Organic amines for use in lixiviants can be selected to have minimal environmental impact. The use of biologically derived organic amines, such as glycine, is a sustainable practice and has the beneficial effect of making processes of the inventive concept more environmentally sound. In addition, it should be appreciated that some organic amines, such as monoethanol-amine, have a very low tendency to volatilize during processing. In some embodiments of the inventive concept an organic amine can be a low volatility organic amine (i.e., having a vapor pressure less than or equal to about 1% that of ammonia under process conditions). In preferred embodiments of the inventive concept, the organic amine is a non-volatile organic amine (i.e., having a vapor pressure less than or equal to about 0.1% that of ammonia under process conditions). Capture and control of such low volatility and non-volatile organic amines requires relatively little energy and can utilize simple equipment. This reduces the likelihood of such low volatility and non-volatile organic amines escaping into the atmosphere and advantageously reduces the environmental impact of their use.

Preferred organic amines can include: Methoxylamine hydrochloride solution, Ethanolamine ACS reagent, Ethanolamine, Ethanolamine hydrochloride, N-(Hydroxymethyl)acetamide, 2-(Methylamino)ethanol, 2-Methoxyethylamine, 3-Amino-1-propanol, Amino-2-propanol, DL-Alaninol, 3-Amino-1,2-propanediol, Serinol, 1,3-Diamino-2-propanol, N-(2-Hydroxyethyl)trifluoroacetamide, N-Acetylethanolamine technical grade, 1-Amino-2-methyl-2-propanol 95% anhydrous basis, 1-Methoxy-2-propylamine, 2-(Ethylamino)ethanol, 2-Amino-1-butanol, 2-Amino-2-methyl-1-propanol, 2-Dimethylaminoethanol, 3-Methoxypropylamine, 3-Methylamino-1-propanol, 4-Amino-1-butanol, 2-(2-Aminoethoxy)ethanol, 3-Methylamino-1,2-propanediol, Diethanolamine, Diethanolamine ACS reagent, Diethanolamine hydrochloride, Tris(hydroxymethyl)aminomethane ACS reagent, 2-(Ethylthio)ethylamine hydrochloride, 2,2′-Oxydiethylamine dihydrochloride, N-(2-Hydroxyethyl)ethylenediamine, meso-1,4-Diamino-2,3-butanediol dihydrochloride, Cystamine dihydrochloride, N-(3-Hydroxypropyl)trifluoroacetamide, trans-2-Aminocyclopentanol hydrochloride, 2-Methylaminomethyl-1,3-dioxolane, 1-Dimethylamino-2-propanol, 2-(Isopropylamino)ethanol, 2-(Propylamino)ethanol, 2-Amino-3-methyl-1-butanol, 3-Dimethylamino-1-propanol, 3-Ethoxypropylamine, 5-Amino-1-pentanol, DL-2-Amino-1-pentanol, 3-(Dimethylamino)-1,2-propanediol, N-Methyldiethanolamine, 2-(3-Aminopropylamino)ethanol, N-(4-Hydroxybutyl)trifluoroacetamide, 1-Amino-1-cyclopentanemethanol, trans-2-Aminocyclohexanol hydrochloride, trans-4-Aminocyclohexanol hydrochloride, 2-(Butylamino)ethanol, 2-(Diethylamino)ethanol, 2-(tert-Butylamino)ethanol, 2-Dimethylamino-2-methylpropanol, 4-(Dimethylamino)-1-butanol, 6-Amino-1-hexanol, DL-2-Amino-1-hexanol, Bis(2-hydroxypropyl)amine, Bis(2-methoxyethyl)amine, N-Ethyldiethanolamine, Triethanolamine reagent grade, L-Leucinol hydrochloride, N,N′-Bis(2-hydroxyethyl)ethylenediamine, 5-Amino-2-chlorobenzyl alcohol, 2-Aminobenzyl alcohol, 3-Aminobenzyl alcohol, 4-Aminobenzyl alcohol, 2-Amino-4-methoxyphenol, 3,4-Dihydroxybenzylamine hydrobromide, 3,5-Diaminobenzyl alcohol dihydrochloride, N-(5-Hydroxypentyl)trifluoroacetamide, 3-(Allyloxycarbonylamino)-1-propanol, 1-Aminomethyl-1-cyclohexanol hydrochloride, trans-2-(Aminomethyl)cyclohexanol hydrochloride, N-Boc-ethanolamine, 3-Butoxypropylamine, 3-Diethylamino-1-propanol, 5-Amino-2,2-dimethylpentanol, 3-(Diethylamino)-1,2-propanediol, 1,3-Bis(dimethylamino)-2-propanol, 2-{[2-(Dimethylamino)ethyl]methylamino}ethanol, 4-Chloro-N-(2-hydroxyethyl)-2-nitro aniline, 2-Amino-1-phenylethanol, 2-Amino-3-methylbenzyl alcohol, 2-Amino-5-methylbenzyl alcohol, 2-Aminophenethyl alcohol, 3-Amino-2-methylbenzyl alcohol, 3-Amino-4-methylbenzyl alcohol, 4-(1-Hydroxyethyl)aniline, 4-Aminophenethyl alcohol, N-(2-Hydroxyethyl)aniline, 3-Hydroxy-4-methoxybenzylamine hydrochloride, 3-Hydroxytyramine hydrobromide, 4-Hydroxy-3-methoxybenzylamine hydrochloride, Norphenylephrine hydrochloride, 5-Hydroxydopamine hydrochloride, 6-Hydroxydopamine hydrobromide, DL-Norepinephrine hydrochloride crystalline, N-(6-Hydroxyhexyl)trifluoroacetamide, 4-Diethylamino-2-butyn-1-ol, Tropine, 3-(Boc-amino)-1-propanol, N-Boc-DL-2-amino-1-propanol, N-Boc-serinol, 2-(Diisopropylamino)ethanol, N-Butyldiethanolamine, N-tert-Butyldiethanolamine, DL-4-Chlorophenylalaninol, 2-(Methylphenylamino)ethanol, 2-Benzylaminoethanol, 3-(Dimethylamino)benzyl alcohol, α-(Methylaminomethyl)benzyl alcohol, 4-(Boc-amino)-1-butanol, N-Boc-DL-2-amino-1-butanol, N-Boc-2-amino-2-methyl-1-propanol, N-Z-Ethanolamine, 2[4-(Dimethylamino)phenyl]ethanol, 2-(N-Ethylanilino)ethanol, α-[2-(Methylamino)ethyl]benzyl alcohol, Ephedrine hydrochloride, N-Benzyl-N-methylethanolamine, 3,5-Dimethoxyphenethylamine, N-Phenyldiethanolamine, Metanephrine hydrochloride, 3-Amino-1-adamantanol, 6-(Allyloxycarbonylamino)-1-hexanol, 5-(Boc-amino)-1-pentanol, N-Boc-DL-2-amino-1-pentanol, 2-(Dibutylamino)ethanol, Benzyl N-(3-hydroxypropyl)carbamate, N-Boc-4-hydroxyaniline, N-(Benzyloxycarbonyl)-3-amino-1,2-propanediol, 2-(N-Ethyl-N-m-toluidino)ethanol, 2,2′-(4-Methylphenylimino)diethanol, N4-Ethyl-N4-(2-hydroxyethyl)-2-methyl-1,4-phenylenediamine sulfate salt, N-Boc-1-amino-1-cyclopentanemethanol, Choline dihydrogencitrate salt, 6-(Boc-amino)-1-hexanol, N-Boc-DL-2-amino-1-hexanol, 4-(Z-Amino)-1-butanol, 2,2′-[4-(2-Hydroxyethylamino)-3-nitrophenylimino]diethanol, 5-(Z-Amino)-1-pentanol, 4-Acetylamino-2-(bis(2-hydroxyethyl)amino)anisole, 3-[Bis(2-hydroxyethyl)amino]propyl-triethoxysilane solution technical, 4-(Z-amino)cyclohexanol, Oxolamine citrate salt, 6-(Z-Amino)-1-hexanol, 2,2-Bis(3-amino-4-hydroxyphenyl)hexafluoropropane, Tris[2-(2-methoxyethoxy)ethyl]amine, 8-Hydroxy-2-(dipropylamino)tetralin hydrobromide, 2-(Fmoc-amino)ethanol, 3-(Dibenzylamino)-1-propanol, 3-(Fmoc-amino)-1-propanol, 4-(Fmoc-amino)-1-butanol, 2-[2-(Fmoc-amino)ethoxy]ethanol, 5-(Fmoc-amino)-1-pentanol, 6-(Fmoc-amino)-1-hexanol, trans-2-(Fmoc-aminomethyl)cyclohexanol, N,N-Bis[2-(p-tolylsulfonyloxy)ethyl]-p-toluenesulfonamide, and (Hydroxymethyl)benzoguanamine, methylated/ethylated.

Preferred organic amines can also include polymer-based amines and salts including, for example, polyetheneimine hydrochloride. Preferred organic amines can also include mixtures of polyamines and/or polyacids and amines, including, for example, polyacrylic acid and ammonia.

Inorganic amines can also be selected for use in lixiviants. Inorganic amines, or azanes, are inorganic nitrogen compounds with the general formula NR₃. Inorganic amines can include ammonia, ammonia borane, ammonium chloride, ammonium acetate, ammonium nitrate, ammonium bromide, chloramine, dichloramine, hydroxylamine, nitrogen tribromide, nitrogen trichloride, nitrogen trifluoride, and nitrogen triiodide. In some embodiments of the inventive concept, an inorganic amine with low vapor pressure relative to other inorganic amines can be used to prevent the off-gassing of inorganic amines.

An example of an application of the inventive concept is in the isolation of insoluble lithium hydroxide (for example, lithium hydroxide formed by treatment of a lithium source with caustic and/or lime), using an ammonium chloride containing lixiviant. Any source that contains or can be processed to contain a basic form of lithium can be suitable for use in a process of the inventive concept. In some embodiments of the inventive concept a lithium source can be selected on the basis of high lithium content per unit mass with high levels of contamination, for example naturally occurring brines and/or low grade ores. Equation 4 represents a reaction that takes place on contacting lithium hydroxide (LiOH)-containing ore or waste with an ammonium chloride lixiviant.

LiOH (solid)+NH₄+ + Cl—→LiCl(soluble)+NH₃ Equation 4

Lithium is extracted from the raw material as soluble lithium chloride (LiCl), with the generation of uncharged ammonia (NH₃) and water. The resulting LiCl can be extracted into a second, non-aqueous liquid phase in some embodiments.

A soluble alkali metal salt, for example lithium chloride and the soluble ammonia from Equation 4 (or soluble ammonium ion if the reaction is metal oxide/hydroxide limited) can easily be separated from the insoluble solid residue, for example, by filtration. Once separated, the soluble aqueous fraction can be used as-is if the target process can tolerate the small quantity of ammonia or ammonium chloride. Alternatively, the solution can be further processed as needed, for example, by extraction into a non-aqueous solid phase and/or precipitation with a source of carbonate (such as CO₂). In a preferred embodiment of the inventive concept, the lixiviant regenerates and the alkali metal lithium recovers as an insoluble salt through the addition of carbon dioxide (CO₂), as shown in Equation 5. Note that aqueous CO² can be in the form of ionized carbonic acid (i.e., 2H+ plus CO₃²⁻).

2 LiCl (soluble)+2 NH₃+CO₂→(Li)₂CO₃ (solid)+2 NH₃+ + 2 Cl— Equation 5

It should be appreciated that systems, methods, and compositions of the inventive concept can also be used to selectively extract and/or refine a desired alkali metal element (such as lithium) from an ore containing other contaminants, for example, other alkali metal elements and/or polyvalent metal salts (e.g. Ti⁴⁺, Fe³⁺, Sn⁴⁺, Bi³⁰ , and Ru³⁺). By using the lixiviants described herein, one skilled in the art can exploit the varying degrees of basicity associated with each alkali metal element, and choose a lixiviant of corresponding acidity to achieve selective extraction. In some embodiments, it is contemplated that lixiviants of varying acidity can be used in sequence to extract multiple alkali metal elements from a single source. In some embodiments one or more non-alkali metal and/or alkali metals can be extracted from a single source in addition to the target alkali metal (e.g. Li) through the application of a selected series of lixiviants.

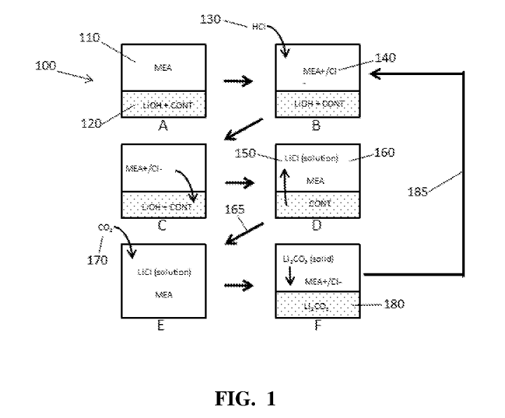

As noted above, in many instances the use of a low volatility and/or non-volatile lixiviant is desirable. An example of such a process of the inventive concept is the extraction of lithium (Li) from an ore using a non-volatile organic amine, such as monoethanolamine hydrochloride, as shown in step A to step F of FIG. 1.

As shown in step A of FIG. 1, a tank 100 or other suitable arrangement includes an aqueous solution of an organic amine 110 (in this instance monoethanolamine) and a mud or slurry 120 containing lithium hydroxide (LiOH) and unwanted contaminants (CONT). The solvent used can be any protic or highly polar solvent that can support the solvation of lithium salts in large amounts. Examples of suitable solvents include water, glycerol, and water/glycerol mixtures. The amount of organic amine can be optimized for efficient alkali metal extraction and minimal use of organic amine.

Reaction conditions can also be optimized by adjusting the surface area available for the reaction. Particle size of the lithium containing raw material can be reduced prior to exposure to lixiviant, for example by grinding, milling, or sifting. In some embodiments of the inventive concept, the particle size can range from about 0.05 mm to about 1 mm. In other embodiments of the inventive concept, the particle size can range from about 0.05 to about 0.25 mm. In a preferred embodiment of the inventive concept, the particle size can range from about 0.05 mm to about 0.125 mm.

The extraction process can be initiated as shown in step B of FIG. 1 by the addition of an acid form of a counterion 130, in this instance hydrochloric acid (HCl), which generates an organic acid cation/counterion pair 140 (in this instance monoethanolamine hydrochloride (MEA+/Cl—)) to form a lixiviant solution. Monoethanolamine hydrochloride (MEA-HCl, HOC₂H₄NH₃Cl) conforms to Compound 1 as follows: one nitrogen atom (N1) is bound to one carbon atom (R1=C₂H₅O) and 3 hydrogen atoms (R2, R3 and H), and there is one chloride counterion (X1=Cl—). The extraction process can be performed at any temperature suitable to support solvation of the alkali metal salt formed by reaction with the organic amine cation/counterion pair. In some embodiments of the inventive concept, the extraction can be performed in a temperature range of about 0° C. to about 120° C. In other embodiments of the inventive concept, the extraction can be performed within a temperature range of about 20° C. to about 100° C. In a preferred embodiment of the inventive concept, the extraction can be performed within a temperature range of about 20° C. and about 70° C., which advantageously reduces the need for temperature control equipment.

As shown in step C of FIG. 1, the lixiviant can enter or mix with the raw material and, as shown in FIG. 1D, selectively form a soluble salt from the desired alkali metal hydroxide, for example, lithium hydroxide (LiOH), by the formation of a soluble alkali metal cation/counterion pair 150 (in this instance, lithium chloride (LiCl). Stirring during the extraction process improves reaction kinetics. In some embodiments, stirrer speeds can range from about 100 rpm to about 2000 rpm. In other embodiments of the inventive concept, stirrer speeds can range from about 200 rpm to about 500 rpm. Equation 6 depicts a critical chemical reaction in such an extraction (in this case, lithium from an ore or other source that contains contaminants). Note that MEA-HCl dissociates in water into monoethanolammonium cation (HOC₂H₄NH₃+ (MEAH+)) and chloride anion (Cl—). Reaction products include soluble LiCl and uncharged monoethanolamine (MEA)).

LiOH(solid or aq.)+HOC₂H₄NH₃+Cl→LiCl(soluble)+HOC₂H₄NH₂ Equation 6

The extraction process can be performed for any suitable length of time, as defined by the amount and quality of the material to be processed. In some embodiments of the inventive concept, the extraction can be performed for 0.5 hours to 24 hours. In other embodiments, the extraction can be performed for about 30 minutes. In preferred embodiments of the inventive concept the extraction can be performed for about 15 minutes. Depending in part on the organic amine species used in the lixiviant, the pH of the solution can change during the extraction process, for example increasing as the alkali metal element is extracted from the sample. In some embodiments of the inventive concept, the pH of the solution at the beginning of the extraction can range from about 6 to about 13. In other embodiments of the inventive concept, the pH at the end of the extraction step can range from about 10 to about 12.

Extraction of a sample with a lixiviant leaves insoluble materials that are not desirable in the final product. These can be removed by a variety of means, including settling, centrifugation, and filtration, as in 165 of step D of FIG. 1. In preferred embodiments of the inventive concept, insoluble materials are removed by filtration, for example in a filter press that produces a filter cake. In order enhance the efficiency of the process, a filter cake from such a filtration can be washed to remove additional extracted lithium. In some embodiments, the filter cake can be treated with a wash volume that is about 10 times that of the wetness of the filter cake. In preferred embodiments of the inventive process, lower volumes can be used, for example about 5 times that of the wetness of the filter cake or about 3 times that of the wetness of the filter cake.

Following separation of the soluble fraction or supernatant from the unreacted contaminants 165, the solubilized alkali metal element can be recovered by the addition of a precipitant 170, for example, carbon dioxide (CO₂), as shown in step E of FIG. 1. In some embodiments of the inventive concept, the soluble metal alkali chloride can be extracted into a non-aqueous solvent prior to this step, with the precipitant 170 being applied to the non-aqueous solvent/alkali metal salt solution. The precipitant acts to form an insoluble salt with the alkali metal element.

Surprisingly, inventors have found that CO₂ precipitation of alkali metal chlorides (for example, LiCl) can proceed efficiently at an acidic pH (i.e., pH<7). Addition of CO₂ (for example, as a gas, or as a carbonate or bicarbonate) also generates the organic amine cation/counterion pair, as shown in step F of FIG. 1 and in Equation 7, thereby regenerating the lixiviant.

2 LiCl(soluble)+2 HOC₂H₄NH₂+CO₂→Li₂CO₃(solid)+2 HOC₂H₄NH₃+ + 2 Cl— Equation 7

In the exemplary reaction, the precipitant forms lithium carbonate (Li₂CO₃) 180 which, being relatively insoluble, can be easily recovered for additional processing and, if desired, recovery of lithium. For example, Li₂CO₃ can be recovered using a filter press, as described above. The regenerated lixiviant can be recycled into the process 185, advantageously reducing the overall need for lixiviant and increasing process efficiency as more raw materials containing alkali metals are processed.

The precipitation reaction can be performed at any temperature suitable to support the solubility of the precipitating agent (for example, CO₂) and maintain the insolubility of the precipitated salt. In some embodiments of the inventive concept the precipitation reaction can be performed at about 4° C. to about 100° C. In other embodiments the precipitation reaction can be performed at about 20° C. to about 80° C. In preferred embodiments of the inventive concept the precipitation can be performed at about 40° C. to about 80° C. The concentration of CO₂ gas supplied can range from about 0.1% to about 100%. In some embodiments of the inventive concept the concentration of CO₂ gas can range from 10% to about 100%. This advantageously permits relatively low quality sources of CO₂, for example flue gas or other waste gases, to be utilized. The CO₂-containing gas can be applied at any rate suitable for conversion of essentially all of the lithium present to Li₂CO₃ within a suitable time, for example about 3 hours to about 4 hours. Suitable flow rates can range from 1 L/hour/mol Li to about 100 L/hr/mol Li. In preferred embodiments of the inventive concept the flow rate for CO₂ containing gas can be about 10 L/hour/mol Li to about 20 L/hour/mol Li. The pH of the solution can change during the precipitation reaction.

The pH of a working solution can change during the precipitation step. In some embodiments of the inventive concept, the starting pH of the solution can range from about 9 to about 12, and can range from about 6 to about 8 at the end of the precipitation. Advantageously, this pH shift can be monitored to provide an indication of the progress of a precipitation reaction. Surprisingly, inventors have found that such a CO₂ precipitation of alkali metal chlorides (for example, LiCl) in this process can proceed efficiently at an acidic pH (i.e., pH<7). The precipitation reaction can be performed until a suitable endpoint is reached. For example, in some embodiments the precipitation can be performed until the pH of the reaction remains below a specified setpoint (for example, a pH of about 8) for at least about 15 minutes.

Separation of the precipitate can be accomplished by any suitable method, including removing the soluble fraction from the tank 100 (for example, by decanting, pumping, or siphoning), filtration, centrifugation, or a combination of these. In a preferred embodiment the precipitate is removed using a filter press. The resulting filter cake can be easily recovered for additional processing and, if desired, recovery of lithium. The regenerated lixiviant can be recycled into the next iteration of the process 185, advantageously reducing the overall need for lixiviant and increasing process efficiency as more raw materials containing alkali metals are processed.

It should be noted that the choice of lixiviant can allow for the selective extraction of lithium in this example because it does not react with other metals (ME) or metal oxides/hydroxides (MEOₓ) in the alkali metal source material, as shown in Equation 8 and Equation 9.

ME(solid)+HOC₂H₄NH₃+(soluble)→NO REACTION Equation 8

MEOₓ(solid)+HOC₂H₄NH₃+(soluble)→NO REACTION Equation 9

The soluble lithium salt from Equation 6 can easily be separated from the insoluble solid residue. Once separated, the soluble lithium-containing fraction can used as-is if the target process can withstand the small quantity of lixiviant as a contaminant, or the solution can be furthered processed as needed.

In an alternative embodiment of the inventive concept, a solution containing an alkali metal cation/counterion complex as shown in Equation 6 can be concentrated or diluted to a desired strength as required by the end user. Alternatively, such a solution can be boiled down or evaporated completely, leaving an alkali metal element cation/counterion salt and/or various hydrates thereof, depending on how vigorously the mixture is dried. The residual uncharged organic amine could also be removed by this process and optionally captured for reuse.

There are of course many possible lixiviants of the form of Compound 1, and there are likewise many alkali metal element sources. While the examples provided have described the action of two organic amine lixiviants (i.e., ammonium chloride and monoethanolamine hydrochloride (a.k.a. monoethanolammonium chloride) with a particular alkali metal element (lithium) other examples of process of the inventive concept can utilize organic amine cation/counterion pairs such as ammonium acetate, monoethanolammonium acetate, ammonium nitrate, or monoethanolammonium nitrate. Alternatively, biologically derived lixiviants such as the amino acid glycine (or a salt of itself) or the hydrobromide salt of poly-L-lysine can be used. Similarly, while isolation of alkali metals from ores, brines, and other natural sources has been noted above, systems, methods, and compositions of the inventive concept can be utilized to recover alkali metal elements from agricultural waste, consumer waste, electronic waste, industrial waste, scrap or other excess materials from manufacturing processes, or other post-utilization sources.

Many alkali metal elements can form hydroxides; most of these have very limited solubility in water. These hydroxides also have varying degrees of basicity. While lithium hydroxide as produced from various mineral sources has been cited as an example there are many other alkali metal elements that form suitable bases in water. Examples of other elements that, in hydroxide form, are suitable for use in systems and methods of the inventive concept includes sodium, potassium, rubidium, and cesium. Such salts have different basicities, which can be paired with organic amine based lixiviants of different acidities to provide selective recovery.

It should also be noted that systems, methods, and compositions of the inventive concept are not limited to one alkali metal species being extracted with one particular lixiviant or set of anions. Multiple alkali metal species with various organic amine based lixiviants and various anions (or acids) can be used in sequence or in parallel to extract a particular mixture of metals or to produce a particular mixture of metal salts.

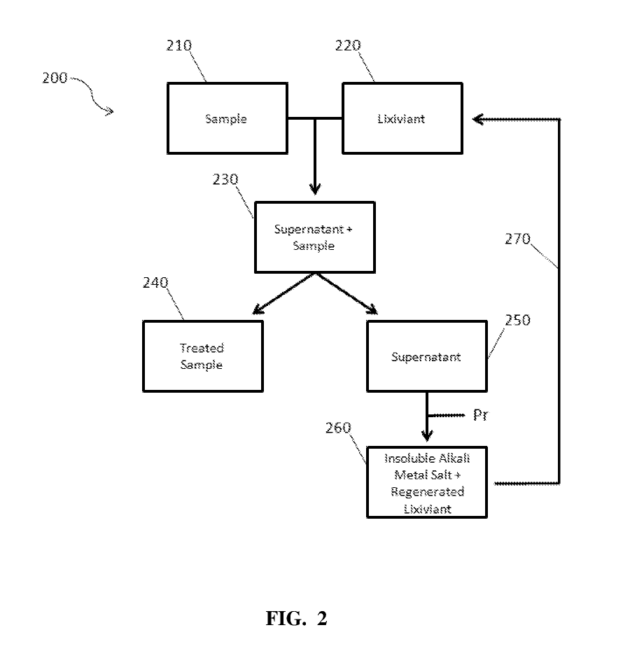

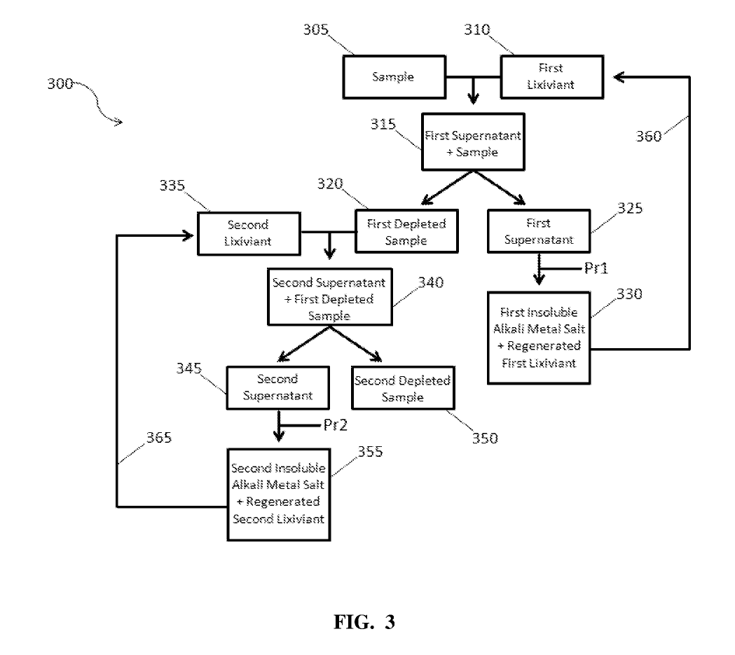

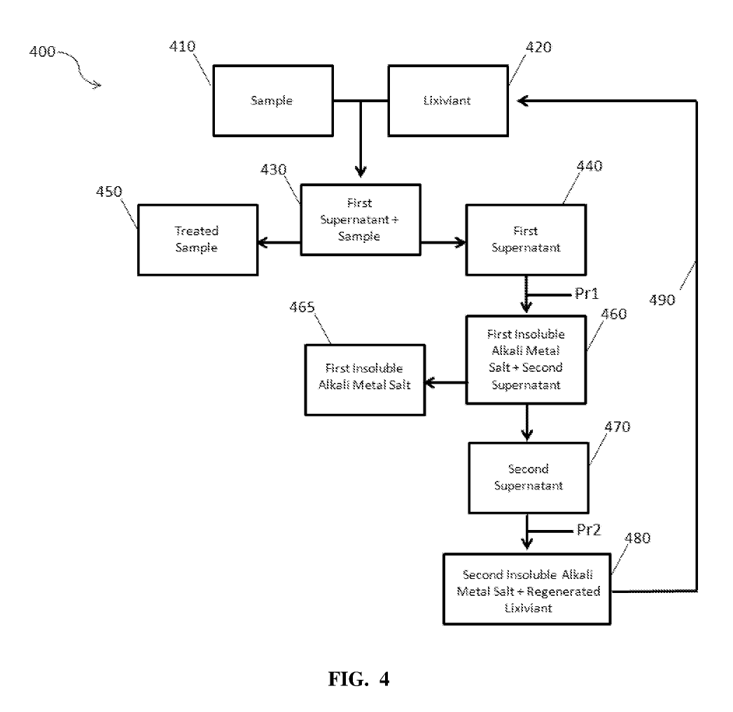

As described above, lixiviants of the inventive concept can be applied in a variety of methods. Examples of some of these methods are depicted schematically in FIG. 2, FIG. 3, and FIG. 4.

FIG. 2 depicts a method of the inventive process 200 in which a sample 210, for example an ore, mineral, brine, waste material, or other source of an alkali metal element, is mixed with a lixiviant 220. The lixiviant can include one or more organic amine species as described above in the form of a cation, coupled with a suitable counterion. Suitable counterions can include halides. In a preferred embodiment of the inventive concept the counterion is chloride (Cl—).

A sample 210 can be a lithium-containing ore, a byproduct of a manufacturing process, or any suitable lithium source. The sample 210 can be treated prior to mixing with the lixiviant 220. For example, the components of the sample 210 can be reduced in size, for example through milling, grinding, pulverizing, or sifting. Such processes improve the surface area to volume ratio of elements of the sample and can serve to increase reaction rates. In some embodiments a sample can be chemically treated, for example through exposure to strong bases (such as sodium hydroxide and or Ca(OH)₂). Such chemical treatments can serve to generate alkali metal salts (for example, hydroxides) and to alter the physical structure of the sample or components of the sample.

On interacting with the lixiviant 220, alkali metal elements in the sample interact with organic amine cations and counterions to form a soluble alkali metal element cation/counterion complex that is solubilized in the supernatant 230, along with an uncharged organic amine. The pH of this portion of the reaction process can be alkaline, i.e., ranging from about 7.5 to about 14. In some embodiments of the inventive concept the pH can range from about 10 to about 12. Unwanted contaminants are not solvated, and remain behind as insoluble material, for example as a treated sample 240 that can be further processed if desired.

The supernatant 250 can be separated from the insoluble materials of the treated sample 240 by a variety of processes, including settling, filtration, or centrifugation, either alone or in combination. The alkali metal cation 260 can be recovered from the supernatant 250 by any suitable means, including electrodeposition, precipitation, and ion exchange. In a preferred embodiment of the inventive concept the alkali metal cation is recovered by the addition of a precipitant (Pr) to produce an insoluble alkali metal salt that is easily recovered. Such precipitants can be an H+ donating species suitable for forming insoluble salts of alkali metal elements while regenerating an organic amine cation, for example CO₂ or carbonic acid, chromic acid, or sulfuric acid. In a preferred embodiment of the inventive concept the precipitant (Pr) is CO₂ or carbonic acid.

Surprisingly, inventors have found that this precipitation can be performed at a pH of less than 7. In such an embodiment a precipitation step can be performed at a pH between about 6 and about 7. In a preferred embodiment a precipitation step can be performed at a pH of about 6.7. The uncharged organic amine remaining in the supernatant 250 can, in turn, be regenerated 270 in this process to form an organic amine cation that can form part of a lixiviant 220 that can be used in the next iteration of the reaction. This recycling of the lixiviant greatly reduces consumption through multiple cycles of the process and advantageously reduces environmental impact and expense.

Other embodiments of the inventive concept can advantageously utilize the selective complex formation and solubility of components of methods of the inventive concept to recover different alkali metal elements from the same sample. One example of such a method is shown in FIG. 3. As shown, such a method can be a chain of reactions that are, essentially, one or more repetitions of the method shown in FIG. 1 applied to a progressively depleted sample. In an example of such a method 300, a sample 305 and a first lixiviant 310 are brought into contact with each other. The first lixiviant 310 includes a first organic amine cation and a counterion, and reaction 315 with the sample 305 produces a first depleted sample 320 and a first supernatant 325 that includes a first alkali metal cation, a counterion, and an uncharged organic amine. The first depleted sample 320 includes materials that were not reactive with the first lixiviant, which can include additional alkali metal elements, other valuable materials, and unwanted contaminants. Depleted samples are advantageously have a higher concentration of the remaining materials as a natural consequence of extracting a portion of the materials into a supernatant, which can increase the commercial feasibility of extracting particular materials from the depleted samples. The depleted samples can also be used directly in creating new products. For example, depleted samples can be incorporated into building materials if the physical properties of the depleted samples are well-suited for construction applications. It can be separated from the first supernatant 325 by any suitable method, including settling, filtration, and centrifugation, either alone or in combination. The first alkali metal cation can be recovered from the first supernatant 325 by any suitable means, including electrodeposition, solvent extraction, precipitation, and/or ion exchange. In a preferred embodiment of the inventive concept a first precipitant (Pr1) can used that generates an insoluble first alkali metal salt and regenerates the first organic amine cation/counterion pair 330. In such an embodiment the uncharged first organic amine remaining in the supernatant 325 can, in turn, be regenerated 360 to give a first organic amine cation that can form part of a first lixiviant 310 that can be used in the next iteration of the process.

The first depleted sample 320 can, in turn, be contacted 340 with a second lixiviant 335 that includes a second organic amine cation/counterion pair. Reaction with the first depleted sample 340 produces a second depleted sample 350 and a second supernatant 345 that includes a soluble second alkali metal element cation/counterion complex and uncharged second organic amine. The second alkali metal cation can be recovered from the second supernatant 345 by any suitable means, including precipitation, electrodeposition, and/or ion exchange. In a preferred embodiment of the inventive concept a second precipitant (Pr2) can be used to generates an insoluble second alkali metal salt and regenerate the second organic amine cation/counterion pair 355.

Such precipitants can be an H+ donating species suitable for forming insoluble salts of alkali metal elements while regenerating an organic amine cation, for example, CO2, carbonic acid, chromic acid, or sulfuric acid. The regenerated second organic amine/counterion pair can in turn be recycled 365 for use in the next iteration of the process. In some embodiments of the inventive concept the first precipitant and the second precipitant are the same species. In other embodiments of the inventive concept the first precipitant and the second precipitant are different species. In a preferred embodiment of the inventive concept the first precipitant and the second precipitant are CO₂ or carbonic acid. In some embodiments of the inventive concept the second depleted sample 350 is subjected to further rounds of treatment with lixiviants in order to recover additional valuable materials. This recycling of the lixiviants advantageously reduces the overall amount of organic amines used as the process is repeated, which limits both the environmental impact of such operations and permits considerable savings in materials.

Another embodiment of the inventive concept that permits recovery of two or more alkali metal elements from a sample is shown in FIG. 4. In such a method 400, a sample 410 is contacted with a lixiviant 420 that includes a first organic amine cation/counterion pair and a second organic amine cation/counterion pair. This mixture 430 results in a treated sample 450 and a first supernatant 440. This first supernatant 440 can include a first alkali metal element cation/counterion pair, a second alkali metal element cation/counterion pair, a first uncharged organic amine, and a second uncharged organic amine. The first alkali metal cation 460 can be recovered from the first supernatant 440 by any suitably selective means, including precipitation, electroplating, or ion exchange. In a preferred embodiment of the inventive concept, the first alkali metal element can be recovered by adding a first precipitant (Pr1) that selectively forms an insoluble salt of the first alkali metal element 460.

Recovery of the second alkali metal cation from the second supernatant 470 also yields a regenerated lixiviant. The second alkali metal cation can be recovered from the second supernatant 470 by any suitable means, such as precipitation, solvent extraction, electrodeposition, and/or ion exchange. In a preferred embodiment of the inventive concept, the second alkali metal element can be recovered by adding a second precipitant (Pr2) that forms an insoluble salt of the second alkali metal element and completes regeneration of the lixiviant 480. The regenerated lixiviant can in turn be recycled 490 in the next iteration of the process.

In some embodiments of the inventive concept, the first organic amine and the second organic amine (and their respective cations) can be different molecular species with different acidities and/or specificities for alkali metal elements. In other embodiments of the inventive concept, the first organic amine and the second organic amine can be the same molecular species, with selectivity between the first alkali metal element and the second alkali metal element being provided by the method used for their recovery from supernatants. For example, utilization of different precipitating species, utilization of the same precipitating species under different conditions (for example, concentration, temperature, pH, or a combination of these), utilization of ion exchange media with different selectivities, or combinations of these approaches can be used to provide selective recovery of the alkali metal elements of a sample. It should be appreciated that, as described in the processes illustrated in FIG. 2 and FIG. 3, that regeneration and re-use of the lixiviant through repeated iterations advantageously reduces the amount of organic amine needed, which limits both the environmental impact of such operations and permits considerable savings in materials.

In some embodiments, the recovery of lithium from lithium-containing materials, such as spodumene ores, lepidolite, petalite, eucryptite, amblygonite, hecotritez and jadarite, increases the concentration of materials remaining after the lithium is removed. It is contemplated that some materials that are not naturally present in sufficient concentrations to be commercially viable can be sufficiently concentrated for commercially viable extraction after lithium is removed. Lithium often naturally occurs with valuable minerals, such as potassium, rubidium, caesium, quartz, tantalum, tin, and albite. For example, higher concentrations of tantalum left in the depleted sample can be commercially viable for extraction and use in high tech applications requiring high resistance to corrosion by acids, such as battery technologies. However, use of depleted material is not limited to the aforementioned embodiments and examples, and any materials present in higher concentrations after the lithium extraction can be processed, incorporated directly into new products, and/or refined.

In another embodiment, the depleted raw materials remaining after lithium extraction can have desirable mechanical properties that are suitable for incorporation into new products. For example, increasing the concentration of remaining minerals resulting from lithium extraction of spodumene ores can yield a material with desirable mechanical properties, such as particular levels of hardness, strength, ductility, fracture toughness, density, and impact resistance, for incorporation into roadbeds or concrete aggregates.

In another embodiment, the depleted raw material remaining after lithium extraction has desirable thermal properties that are suitable for temperature-specific applications. For example, a depleted raw material containing high concentrations of silica having high heat tolerance and sufficient hardness on the Mohs scale can be used in structural applications exposed to high heat, such as in laboratory applications where temperatures can reach above 1000° Fahrenheit.

In yet another embodiment, the depleted raw materials have specific chemical properties that are suitable for incorporation into new products. For example, a depleted raw material with high levels of tantalum, which has high corrosion resistance and triggers no immune response, may be used in a outdoor structure that comes into direct contact with people every day. In some embodiments, depleted raw materials can be further processed prior to incorporation into new products.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for extracting an alkali metal element, comprising:
contacting a sample comprising a first alkali metal salt with a first lixiviant, the first lixiviant comprising a first amine cation and a first counterion,
wherein the first alkali metal salt comprises a first alkali metal element,
wherein the first lixiviant is selected to react selectively with the first alkali metal salt, and
wherein the first lixiviant is added in a substoichiometric amount relative to the amount of the first alkaline metal element available in the first alkali metal salt;
forming a depleted sample and a first supernatant comprising a first uncharged or charged amine, and a first soluble complex comprising a cation of the first alkali metal element and the first counterion;
transferring the first alkali metal element cation from the first supernatant; and
regenerating the first amine cation by the addition of a first precipitant or salt forming agent.

2. The method of claim 1, wherein the step of transferring comprises extraction of the first alkali metal cation into a water-immiscible solvent.

3. The method of claim 2, wherein the water-immiscible solvent is an alcohol.

4. The method claim 1, wherein the pH during regeneration of the amine cation is less than about 10.

5. The method of claim 1, wherein the pH during regeneration of the amine cation is greater than 6 and less than 10.

6. The method of claim 1, wherein the lixiviant is formed by adding an acid to the uncharged amine in the presence of the sample.

7. The method of claim 1, further comprising a step of using at least a portion of the regenerated amine cation to contact the sample comprising an alkali metal element.

8. The method of claim 1, wherein the first precipitant is carbon dioxide, carbonic acid, bicarbonate or carbonate material.

9. The method of claim 1, wherein the sample comprises a second alkali metal element, and comprising the additional steps of:
contacting the depleted sample with a second lixiviant, the second lixiviant comprising a second amine cation and a second counterion;
forming a second supernatant comprising an uncharged second amine and a second complex comprising a second alkali metal element cation and the second counterion;
transferring the second alkali metal cation from the depleted sample; and
regenerating the second amine cation by the addition of a second precipitant.

10. The method of claim 9, wherein the first precipitant is carbon dioxide, carbonic acid, bicarbonate or carbonate material.

11. The method of claim 1, wherein the depleted sample and the first supernatant contain a desired product and the first alkali metal element cation contains an undesired product.

12. A method for extracting alkali metal elements, comprising:
contacting a sample comprising a first alkali metal salt and a second alkali metal salt with a lixiviant, the lixiviant comprising a first amine cation, a second amine cation, and a counterion, wherein the first alkali metal salt comprises a first alkali metal element and the second alkali metal salt comprises a second alkali metal element, wherein the first amine cation is selected to react selectively with the first alkali metal salt and the second amine cation is selected to react selectively with the second alkali metal salt;
forming a first supernatant comprising an uncharged first amine, an uncharged second amine, a first complex comprising a first alkali metal element cation and the counterion, and a second complex comprising a second alkali metal element cation and the counterion;
transferring the first alkali metal element cation from the first supernatant to form a second supernatant;
transferring the second alkali metal element cation from the second supernatant; and
regenerating the first amine cation and the second amine cation from the second supernatant,
wherein the first amine cation is regenerated by the addition of a first precipitant.

13. The method of claim 12, wherein the first amine cation and the second organic amine cation are the same species.

14. The method of claim 12, wherein the first amine cation and the second amine cation are different species.

15. The method claim 12, wherein the first alkali metal element is precipitated from the first supernatant by the addition of the first precipitant.

16. The method of claim 12, wherein the second alkali metal element is precipitated from the second supernatant by the addition of a second precipitant.

17. The method of claim 12, wherein the second precipitant is carbon dioxide, carbonic acid, bicarbonate, or carbonate material.

18. A lixiviant for extracting alkali metal elements, comprising:
an amine cation; and,
a counterion;
wherein the amine cation is formulated to selectively transfer the counterion to a desired insoluble alkali metal salt to form an uncharged amine or charged amine, and wherein the uncharged amine is formulated to react with a precipitant to regenerate the amine cation, and
wherein the amine cation is at least one of an organic amine or an inorganic amine.

19. The lixiviant of claim 18, wherein the amine cation has a vapor pressure less than about 1% that of ammonia.

20. The lixiviant of claim 18, wherein the amine cation has a pKa between 8 and 14.

21. The method of claim 1, wherein the first lixiviant has a pKa between 8 and 12
